(19) United States
(12) Patent Application Publication
(10) Pub. No.: US 2007/0282525 A1
(43) Pub. Date: Dec. 6, 2007

(54) Navigation system and program product

(75) Inventor: Satoshi Tagawa, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/798,796

(22) Filed: May 17, 2007

(30) Foreign Application Priority Data
May 30, 2006 (JP) 2006-150083

(51) Int. Cl. G01C 21/32

(52) U.S. Cl. 701/209; 340/995.1

(57) ABSTRACT

A CPU of a navigation system in a vehicle executes a determination as to whether there is a passable route to a main road via a passage, which is within a predetermined range from a vehicle's position. This determination is executed based on map data indicating (i) a road network and (ii) information on roads included in the road network. According to a result of the determination, a user of the vehicle is guided in the passable route.

### CROSS REFERENCE TO RELATED APPLICATION

This application is based on and incorporates herein by reference Japanese Patent Application No. 2006-150083 filed on May 30, 2006.

### FIELD OF THE INVENTION

The present invention relates to a technology which guides a user or occupant of a vehicle in a passable route.

### BACKGROUND OF THE INVENTION

Patent document 1 describes a navigation system as follows. A subject vehicle travels or moves forward on a certain link. Map data indicates a road as an aggregation of multiple connected links. A forward connection of the certain link is checked based on the map data. When the certain link is not connected to any other forward link, a user is informed that the forward of the road is a dead end.

Patent document 2 describes another navigation system as follows. A shortcut route is searched for when a vehicle is at an intermediate position in a recommended or guide route. When there is a shortcut route, a user is informed of the shortcut route.

Patent document 1: JP-H10-260054 A

Patent document 2: JP-H11-211498 A

A user may take a back road (i.e., passage) or change a route when a main road where the vehicle is traveling is in a traffic congestion.

In this case, the navigation system of Patent document 1 is not useful since it only determines whether the forward of the currently traveled main road has a dead end and it has no capability of teaching the user a route passable to another main road or returnable to the current main road.

In contrast, the navigation system of Patent document 2 is also not useful since it only searches for a shortcut connected with and returning to the current main road and the user is therefore informed of the passage only when the main road is included in the recommended route and the passage is a route starting with and ending with the currently traveled main road.

In other words, even when a passage which can reach another main road is present, the above navigation systems do not allow a user to easily recognize the passage.

### SUMMARY OF THE INVENTION

It is an object of the present invention to provide a technology which allows a user or occupant of a vehicle to easily recognize a passable route which can reach a road assigned with a specified category.

To achieve the above object, according to an aspect of the present invention, a navigation system for a vehicle is provided as follows. A position detector is configured to detect a current position of the vehicle. A map data obtaining unit is configured to obtain map data for indicating (i) a road network and (ii) information on roads included in the road network. A passable route determination unit is configured to execute a determination as to whether there is a passable route based on the obtained map data, the passable route allowing the vehicle to travel via a first-category road to a second-category road. The first-category road is present within a predetermined range from the detected current position. The first-category road and the second-category road are defined based on the information on roads indicated by the obtained map data. A passable route guide unit is configured to guide a user in the passable route based on a result of the determination.

### BRIEF DESCRIPTION OF THE DRAWINGS

The above and other objects, features, and advantages of the present invention will become more apparent from the following detailed description made with reference to the accompanying drawings. In the drawings:

FIGS. 1A, 1B illustrate schematic external views of a navigation system according to an embodiment of the present invention;

FIG. 2 is a block diagram illustrating an internal configuration of the navigation system;

FIG. 3 is a flowchart diagram illustrating a search mode process;

FIG. 4 is a diagram for explaining a display example of a result of searching for a passage;

FIG. 5 is a first guide example performed when multiple passable routes are present;

FIG. 6 is a second guide example performed when multiple passable routes are present; and

FIG. 7 is a third guide example performed when multiple passable routes are present.

### DETAILED DESCRIPTION OF THE PREFERRED EMBODIMENTS

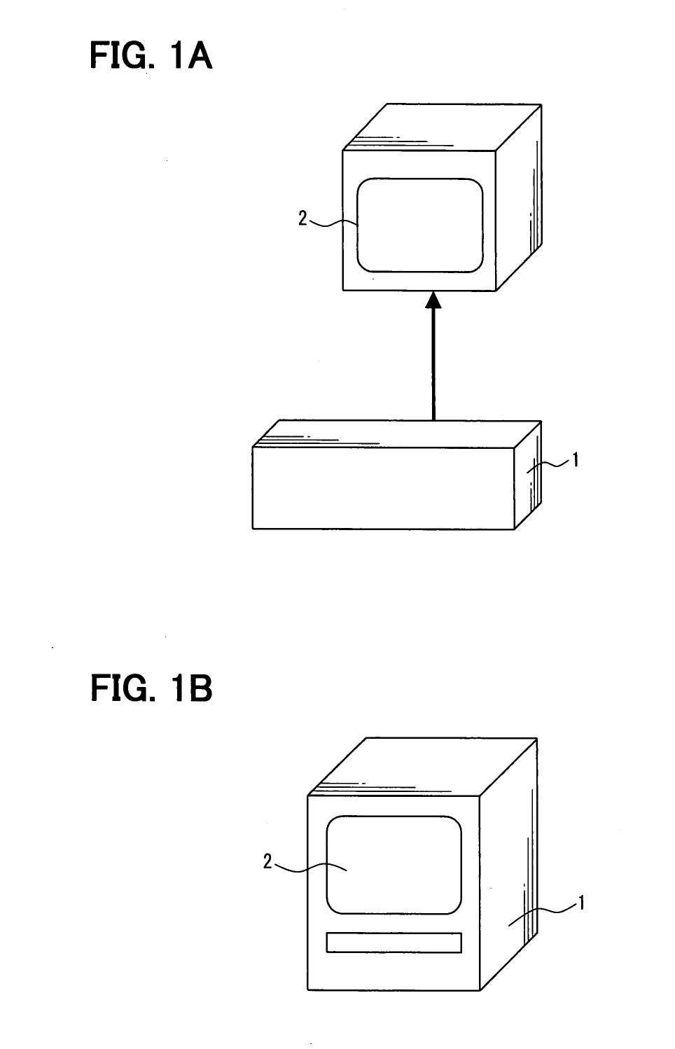

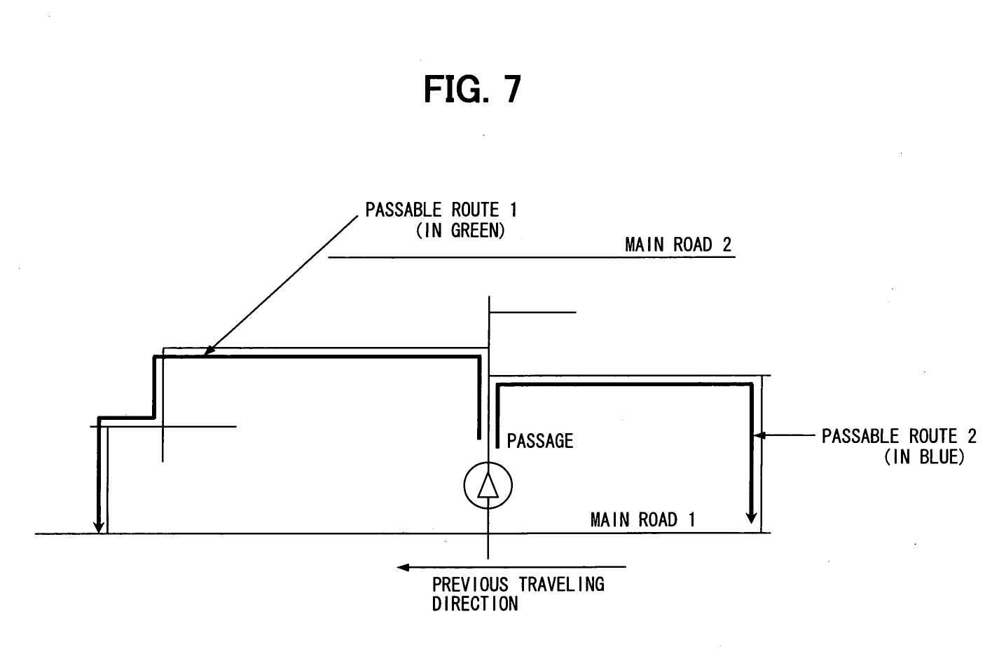

An embodiment of the present invention will be explained with reference to FIGS. 1 to 7. FIGS. 1A, 1B illustrate schematic external views of a navigation system 1 according to the embodiment. FIG. 1A illustrates the navigation system 1, which is separated from a display device 2. FIG. 1B illustrates the navigation system 1, which is integrated with the display device 2.

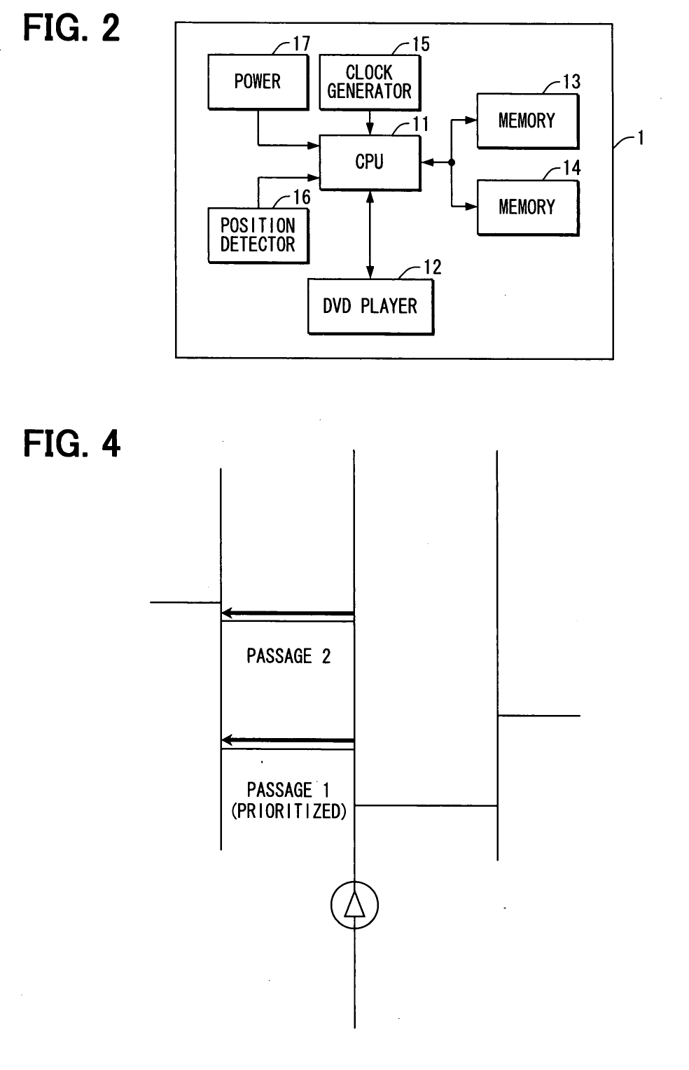

The display device 2 has a screen including a touch sensitive panel, via which a user can perform an input operation. FIG. 2 illustrates a block diagram of the internal configuration of the navigation system 1.

The navigation system 1 includes a CPU 11, a DVD player 12, memory devices 13, 14, a clock signal generator 15, a position detector 16, and a power source 17.

The CPU 11 performs various processes based on programs and/or data stored in the memory devices 13, 14. The DVD player 12 reads a program and/or data stored in a DVD to output to the CPU 11 based on an instruction from the CPU 11. The DVD stores map data and various application programs. The map data include a road network, positions of roads included in the road network, and classes of the roads, and dimensions or sizes (length, width, height, etc.) of the roads. The classes of roads are, for instance, a freeway, a highway, a throughway, a local road, a residential road, a private road, a walkway, a non-navigable road, an under-construction or planning road, a ferry route, a car train, or the like. The application programs are used for the CPU 11 to perform navigation.

The memory device 13 stores (i) a boot program for starting the CPU 11 and (ii) data of designs shown on the screen of the display device 2. The memory device 14 stores (i) map data, which the CPU 11 reads from the DVD player 12, (ii) various application programs, and (iii) data indicating a size (length, width, height, etc.) of a vehicle, in which the navigation system 1 is mounted.

The clock signal generator 15 generates a clock signal with predetermined intervals and outputs the generated clock signals to the CPU 11. The position detector 16 includes a gyroscope and a GPS receiver and outputs a signal necessary for computing a current position of the vehicle to the CPU 11. The power source 17 supplies an electric power to the CPU 11 and other components of the navigation system 1.

Next, a search mode process as one of the various processes by the CPU 11 will be explained below.

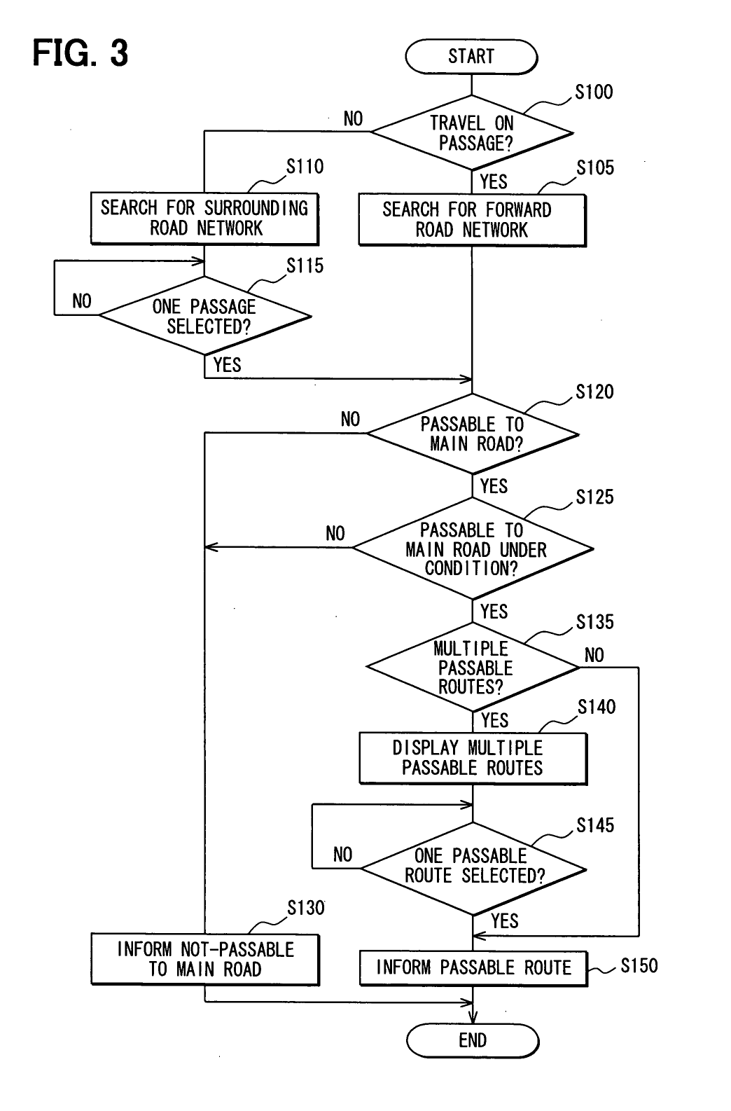

FIG. 3 is a flowchart diagram illustrating the search mode process. The program of the search mode process is stored in the DVD as one of the various application programs. The CPU 11 starts this process when the search mode is switched from OFF state to ON state by an input operation of the user or occupant in the vehicle.

At Step S100, it is determined whether the vehicle travels on a first-category road (e.g., a passage or back road). This is determined based on a current position of the vehicle computed by the CPU using output signals from the position detector 16 and a road class or dimension of a road corresponding the current position of the vehicle. Here, a first-category road is, for instance, assigned to a passage, which branches from a main road or which is smaller in a dimension by a predetermined value than a main road; a second-category road is, for instance, assigned to a main road. Further, for instance, a main road includes a freeway, a highway, a throughway, or a local road; a passage includes a residential road, a private road, a walkway, a non-navigable road, an under-construction or planning road, or the like. Thus, the CPU 11 functions as a means for defining a first-category road and a second-category road based on the map data stored in the DVD.

When the vehicle travels on a passage (S100: YES), the CPU 11 searches for a road network, which is present forward of the vehicle (i.e., in the heading direction of the vehicle) and is present within a predetermined range from the current position of the vehicle (S105). Then S120 is performed.

In contrast, when the vehicle does not travel on a passage (S100: NO) (i.e., when the vehicle travels on a second-category road (e.g., a main road)), the CPU 11 searches for a road network, which is present within a predetermined range from the current position of the vehicle (S110). Here, the CPU 11 searches for a passage as a first-category road, which leads the vehicle towards a given direction (e.g., a direction for turning left) such that the vehicle branches from the heading direction of the main road as a second-category road.

The CPU 11 shows passages as the result of the search in the screen of the display device 2 (see FIG. 4) and waits until the user selects one of the displayed passages with an input operation (S115: NO).

When one of the passages is selected (S115: YES), it is then determined whether the vehicle can reach a main road as a second-category road via the selected passage, as a first-category road, without turning around (S120). For instance, it is determined whether the selected passage is connected to a main road and whether the selected passage includes a section having dimensions smaller than those of the vehicle. When Step S120 is performed after Step S105, it is determined whether the vehicle can reach a main road via the currently traveled passage without turning around (S120) by determining whether the currently traveled passage is connected to a main road and whether the currently traveled passage includes no section having dimensions smaller than those of the vehicle (S120).

When the vehicle cannot reach a main road via the passage (S120: NO), S130 is then performed; namely, the user is informed that the vehicle cannot reach a main road via the passage via the display device 2 (S130). The process is then terminated.

In contrast, when the vehicle can reach a main road via the passage (S120: YES), it is determined whether the vehicle can reach the main road via the passage under a predetermined condition, (i.e., within a designated distance and within a designated time) (S125). The designated distance and designated time are designated by input operations by the user. When the determination at Step S125 is negated, the user is informed that the vehicle cannot reach a main road via the display device 2 (S130). The process is then terminated.

In contrast, when the determination at Step S125 is affirmed, it is determined whether there are multiple passable routes (S135). When only one passable route is present (S135: NO), Step S150 is then performed; namely, the user is informed that the vehicle can reach a main road in the corresponding passable route via the display device 2 (S150). The process is then terminated.

When multiple passable routes are present (S135: YES), the multiple passable routes are shown on the display device 2 (S140) in association with priority orders, which are determined based on a predetermined condition. Thus, the user is informed of the multiple passable routes associated with the priority orders.

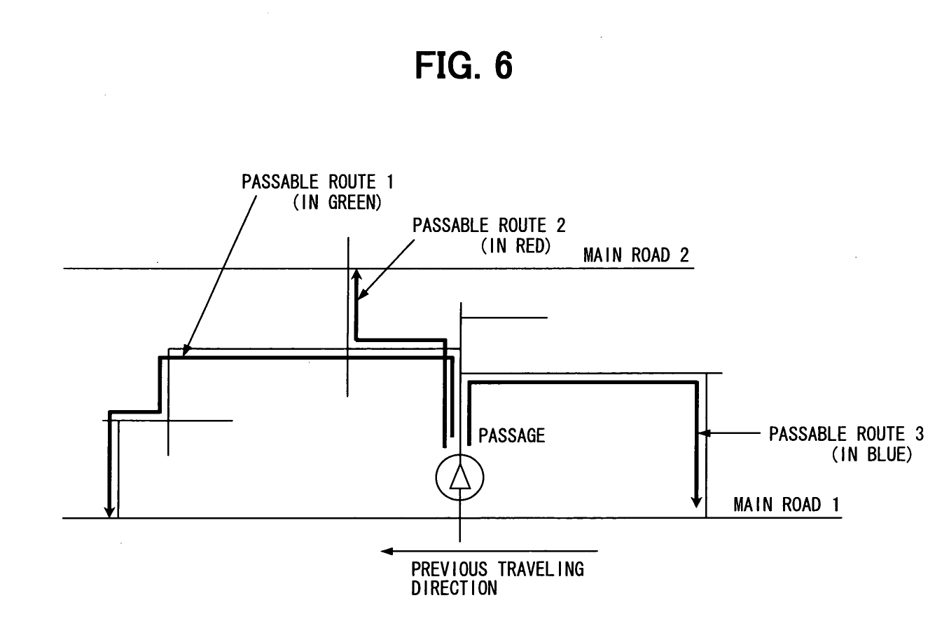

For instance, the highest priority is assigned to a first passable route explained as follows. In the first passable route, the vehicle moves forward in a certain direction on a first main road, then branches from the first main road at a first point to enter the passage, and returns to the first main road at a second point, which is located forward in the certain direction compared with the first point (see PASSABLE ROUTE 1 (IN GREEN) in FIG. 6).

For instance, the second highest priority is assigned to a second passable route explained as follows. In the second passable route, the vehicle moves forward in a certain direction on a first main road, then branches from the first main road at a first point to enter the passage, and returns to the first main road at a second point, which is located backward in the certain direction compared with the first point (see PASSABLE ROUTE 3 (IN BLUE) in FIG. 6).

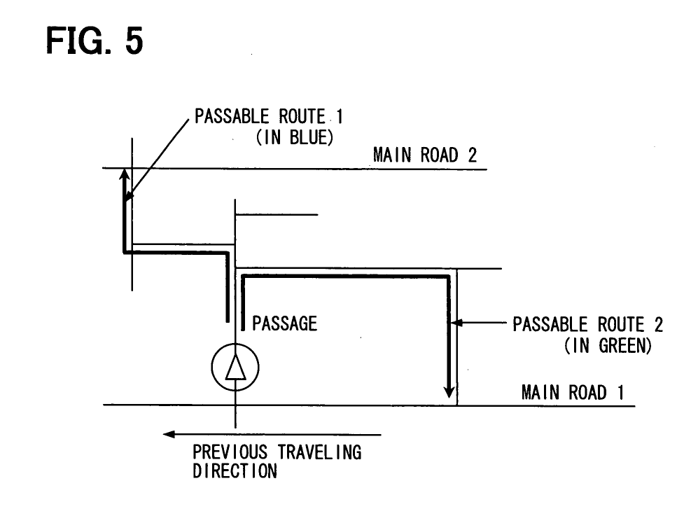

For instance, the third highest priority is assigned to a third passable route explained as follows. In the third passable route, the vehicle travels on a first main road, then branches from the first main road to enter the passage, and enters a second main road different from the first main road (see PASSABLE ROUTE 2 (IN RED) in FIG. 6). Here, the multiple passable routes are illustrated in colors individually corresponding to the priority orders (e.g., in the order of green, blue, and red), as shown in FIGS. 5, 6, 7.

The CPU 11 waits until an input operation by the user designates one of the multiple passable routes (S145: NO). When one of the multiple passable routes is designated (S145: YES), the user is informed and guided in the designated passable route (S150). The process is then terminated.

Thus, according to the navigation system 1, when a passage is present within a predetermined range from the current position of the vehicle and is included in a passable route which allows the vehicle to enter a main road, the user is informed of the passable route to thereby easily recognize the passable route.

Further, a passage, which is designated by an input operation of the user, is determined to constitute a passable route or not when the search mode is set to ON state while the vehicle travels on a main road. This allows the user to easily recognize whether a passage which the user wants to use is actually included in a passable route.

Further, when the search mode is set to ON state while the vehicle travels on a passage, this passage is determined to constitute a passable route or not. The user thus can easily recognize whether the passage on which the vehicle travels is included in a passable route or not. This allows the user to promptly respond when a passage, on which the vehicle travels, is not included in a passable route.

Further, when multiple passable routes are present, a certain passable route of the multiple passable routes is designated by an input operation of the user and the user is informed with respect to the designated certain passable route. Thus, the user can designate a passable route as a guide target. This allows the user to be informed or guided with respect to only the designated passable route.

When multiple passable routes are present, priority orders are assigned based on a predetermined condition. The user is informed of the passable routes associated with the individual priority orders and therefore easily determines which passable route should be used.

In the above embodiment, Steps S100 to S125 performed by the CPU 11 can be achieved as a passable route determination unit; Steps S130, S145, S150 performed by the CPU 11 can be achieved as a passable route guide unit. Further, Steps S135, S140 performed by the CPU 11 can be achieved as a priority guide unit.

The map data and/or various application programs are stored in the DVD; however, another storage medium other than the DVD may be alternatively used. In this case, the navigation system 1 may be provided with a player or reader corresponding to the used storage medium. Furthermore, the map data and/or various application programs can be stored within an HDD (Hard Disk Drive).

The navigation system 1 can obtain the map data from an outside information center or server by downloading it instead of obtaining it from the storage medium. The passable route is informed to the user on the screen of the display device 2; however, it may be informed as an audio guide by installing a speaker in the vehicle.

Further, a first-category road or a second-category road may be assigned to any road class or any combinations of road classes as long as the CPU 11 or passable route determination unit can determine whether there is a passable route which allows a vehicle to travel via a first-category road to a second-category road.

Each or any combination of processes, steps, or means explained in the above can be achieved as a software unit (e.g., subroutine) and/or a hardware unit (e.g., circuit or integrated circuit), including or not including a function of a related device; furthermore, the hardware unit can be constructed inside of a microcomputer.

Furthermore, the software unit or any combinations of multiple software units can be included in a software program, which can be contained in a computer-readable storage media or can be downloaded and installed in a computer via a communications network.

Aspects of the subject matter described herein are set out in the following clauses.

As a first aspect, a navigation system for a vehicle comprises: a position detector configured to detect a current position of the vehicle; a map data obtaining unit configured to obtain map data for indicating (i) a road network and (ii) information on roads included in the road network; a passable route determination unit configured to execute a determination as to whether there is a passable route based on the obtained map data, the passable route allowing the vehicle to travel via a first-category road to a second-category road, the first-category road being present within a predetermined range from the detected current position, the first-category road and the second-category road being defined based on the information on roads indicated by the obtained map data; and a passable route guide unit configured to guide a user in the passable route based on a result of the determination.

In this structure, when the vehicle can reach a second-category road via a certain route including a first-category road, which is within a predetermined range from the current position of the vehicle, the user of the vehicle is informed of or guided in the certain route. This allows the user to easily recognize the route, which is passable to the second-category road.

The passable route determination unit may determine whether a passable route includes a single first-category road or more than one first-category road.

Any class of roads can be assigned to a first-category road or a second-category road. The map data may be previously stored either inside or outside of the navigation system.

The map data may indicate dimensions (i.e., length, width, height, etc.) of each road. Thus, the passable route determination unit compares the first-category road with the vehicle in dimensions to thereby determine whether the first-category road can be a passable route for the vehicle to pass through. Further, the passable route determination unit computes a travel time based on the dimension of the first-category road and a vehicle speed to thereby determine whether the first-category road can be a passable route for the vehicle to pass through within a predetermine time. Further, the passable route determination unit may determine whether the first-category road can be a passable route for the vehicle to pass through within a predetermine travel distance.

The passable route guide unit may guide the user in the passable route via not only a display device but also a speaker. When the passable route determination unit determines that there is no passable route, the passable route guide unit may inform the user that there is no passable route. When the passable route determination unit determines that there is multiple passable routes, the passable route guide unit may inform the user of all or part of the multiple passable routes.

Thus, in the navigation system of the first aspect, as additional aspect, the information on roads includes, with respect to each road, at least one of a road class and a dimension, in addition to a position. Here, the first-category road and the second-category road may be differentiated from each other based on the at least one of the road class and the dimension.

In the navigation system of the first aspect, as additional aspect, the second-category road is a main road, and the first-category road is a passage, which branches from a main road. In this case, the second-category road may include a freeway, a highway, a throughway, or a local road; the first-category road may be a road other than the main road, or a road smaller than the second-category road.

In the navigation system of the first aspect, as additional aspect, when the first-category road is previously designated by an external input, the passable route determination unit starts executing the determination.

In the navigation system of the first aspect, as additional aspect, when the detected current position of the vehicle is included in the first-category road, the passable route determination unit starts executing the determination.

In the navigation system of the first aspect, as additional aspect, when the passable route determination unit determines that there are multiple passable routes, the passable route guide unit guides the user in a passable route, which is included in the multiple passable routes and designated by an external input.

In the navigation system of the first aspect, as additional aspect, a priority guide unit is included to (i) execute, based on a predetermined condition, a priority determination of orders of priorities in multiple passable routes when the passability determination unit determines that the multiple passable routes are present, and (ii) guide the user based on a result of the priority determination.

As another aspect, a computer program product in a computer-readable medium for a use in navigation for a vehicle comprises: instructions for executing a determination as to whether there is a passable route, based on map data indicating (i) a road network, (ii) positions of roads included in the road network, and (iii) categories of the roads, the passable route allowing the vehicle to travel via a first-category road to a second-category road, the first-category road being within a predetermined range from a current position of the vehicle; and instructions for guiding a user in the passable route based on a result of the determination.

It will be obvious to those skilled in the art that various changes may be made in the above-described embodiments of the present invention. However, the scope of the present invention should be determined by the following claims.

What is claimed is:

1. A navigation system for a vehicle, the system comprising:
a position detector configured to detect a current position of the vehicle;
a map data obtaining unit configured to obtain map data for indicating (i) a road network, and (ii) information on roads included in the road network;
a passable route determination unit configured to execute a determination as to whether there is a passable route based on the obtained map data, the passable route allowing the vehicle to travel via a first-category road to a second-category road, the first-category road being present within a predetermined range from the detected current position, the first-category road and the second-category road being defined based on the information on roads indicated by the obtained map data; and
a passable route guide unit configured to guide a user in the passable route based on a result of the determination.

2. The navigation system of claim 1, wherein:
the information on roads includes, with respect to each road, at least one of a road class and a dimension, in addition to a position; and
the first-category road and the second-category road are differentiated from each other based on the at least one of the road class and the dimension.

3. The navigation system of claim 1, wherein:
the second-category road is a main road; and
the first-category road is a passage, which branches from a main road.

4. The navigation system of claim 1, wherein
when the first-category road is previously designated by an external input, the passable route determination unit starts executing the determination.

5. The navigation system of claim 1, wherein
when the detected current position of the vehicle is included in the first-category road, the passable route determination unit starts executing the determination.

6. The navigation system of claim 1, wherein
when the passable route determination unit determines that there are multiple passable routes, the passable route guide unit guides the user in a passable route, which is included in the multiple passable routes and designated by an external input.

7. The navigation system of claim 1, further comprising:
a priority guide unit configured to (i) execute, based on a predetermined condition, a priority determination of orders of priorities in multiple passable routes when the passability determination unit determines that the multiple passable routes are present, and (ii) guide the user based on a result of the priority determination.

8. A computer program product in a computer-readable medium for a use in navigation for a vehicle, the product comprising:
instructions for executing a determination as to whether there is a passable route, based on map data indicating (i) a road network, and (ii) information on roads included in the road network, the passable route allowing the vehicle to travel via a first-category road to a second-category road, the first-category road being within a predetermined range from a current position of the vehicle, the first-category road and the second-category road being defined based on the information on roads indicated by the map data; and
instructions for guiding a user in the passable route based on a result of the determination.
